(19) United States
(12) Patent Application Publication
(10) Pub. No.: US 2007/0142085 A1
(43) Pub. Date: Jun. 21, 2007

(54) Method for connecting a radiocommunication device to a data transfer device, radiocommunication and transfer devices, and corresponding connection means

(75) Inventors: Laurent Girault, Plaisir (FR); Eric Blum, Paris (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Wavecom, Issy-Les-Moulineaux Cedx (FR)

(21) Appl. No.: 10/565,546

(22) PCT Filed: Jul. 26, 2004
(86) PCT No.: PCT/FR04/02001

§ 371 Date: Aug. 11, 2006

(30) Foreign Application Priority Data
Jul. 25, 2003 (FR) 0309190

(51) Int. Cl. H04B 1/38

(52) U.S. Cl. 455/558

(57) ABSTRACT

The disclosure relates to a method for connecting a radiocommunication device to a data transfer device, whereby said transfer device is connected to said radiocommunication device via a housing for receiving and connecting a removable electronic card (SIM).

The domain of the invention relates to radiocommunication devices, in particular wireless telephones and radiocommunication devices designed to be mounted, for example, in machines or vehicles.

More specifically, the invention relates to programming, updating, and/or reading data from means contained in such a terminal, and more generally, access to these means.

Indeed, this type of access is often needed to insert a program corresponding to a specific application in the terminal (and, for example, in the module that includes the intelligence of the latter) in order to enter corrections or updates, or to collect specific data.

To perform these operations, the wireless telephony terminal is connected to a micro-computer, for example a PC. A standard interface can be used, for example, a UART (Universal Asynchronous Receiver/Transmitter) interface at the PC end.

At the wireless telephony terminal end, different connector types are offered by different manufacturers. Access to the module is therefore possible, in the case of wireless telephones, via these connectors, as long as a specific link cable is available (which assumes that there is a plurality of different cables available to allow acting on several different types of wireless telephones.)

Nevertheless, access to this type of connector is much more problematic when the radiocommunication means are mounted on machines, remote measuring terminals, vehicles, etc. Thus, for example, it is understood that an automobile manufacturer that integrates wireless telephony means would like these ones to be fully integrated and would not accept, for aesthetic or ergonomic, or even due to costs, and difficulty in mounting, having to install access to this type of connector.

It would be difficult to image, for example, that a manufacturer would accept mounting this type of connector on the vehicle dashboard, and in particular in luxury vehicles.

Furthermore, this would limit the manufacturer to using a specific type of connector, from among the existing types of connectors, and therefore limit the possibilities of exchange or upgrade.

On the other hand, for those that might intervene in several types of vehicles, the same number of interfaces as connectors would have to be available.

The same type of situation arises in machines equipped with wireless telephony means in which the latter are integrated in a small space that is generally difficult to access. Consequently, it is very difficult for a user to establish the connection, unless they provide for retransmission means, which then to be cumbersome, difficult to mount, and costly.

In particular, the purpose of the invention is to overcome the various disadvantages of the previous art.

More specifically, the purpose of the invention is to provide a technique that allows exchanging data between the internal means of a wireless telephony device and a programming and/or reading system that does not require the implementation of a specific connector on the radiocommunication device.

The purpose of the invention is to provide such a technique, allowing easy and efficient access to these internal means, without the need to develop specific connection means at the wireless telephony device end.

Another purpose of the invention is to provide such a technique that allows universal access to all radiocommunication devices, regardless of their source and distributor.

Another purpose of the invention is to provide such a technique, which allows simplifying radiocommunication devices, reducing their cumbersome aspect, and their cost price.

It can be noted here that the radiocommunication device includes, not only the terminals, but also the radiocommunication means that can be mounted on a machine, vehicle, etc.

These goals, as well as other that are described below, are achieved according to the invention by using a method for connecting a radiocommunication device to a data transfer device, according to which said transfer device is connected to said radiocommunication device is performed via a housing for receiving and connecting a removable electronic card (SIM).

Thus, according to the invention, there is no need to provide a specific connector, which is sometimes difficult to access. A SIM connector is used, which by definition, is accessible.

Furthermore, the cost of radiocommunication devices is decreased and a universal efficient connection is offered.

According to an advantageous embodiment of the invention, the method comprises the following stages:
extracting the removable electronic card (SIM);
inserting into said housing a connector with a connection format that includes at least one link point that is compatible with a link point equipped in said radiocommunication device for receiving said removable electronic card (SIM);
transferring the data between said transfer device and said radiocommunication device.

Preferably, according to the invention, there are two operating modes of said radiocommunication device; a first normal operating mode that requires the presence of said removable electronic card (SIM), and a second data transfer mode that requires a connector instead of said removable electronic card (SIM).

Thus, advantageously, said radiocommunication device goes into said second mode due to one of the following actions:
reception by said radiocommunication device of a specific command;
detection of the presence of a specific transfer connector and/or absence of the removable electronic card (SIM);
action on at least one key of said radiocommunication device.

Advantageously, the method of the invention includes a data transfer stage, from said transfer device, that corresponds to at least one of the elements belonging to the group that comprises:
specific implementation programs for said radiocommunication device according to a predetermined application;
program and/or parameter updates;
configuration data of at least one program;
data dedicated to at least one program.

The method of the invention can also advantageously comprise, as an addition or optional alternative, a data transfer stage from said radiocommunication device to said transfer device.

The invention also relates to radiocommunication devices that can be connected to a data transfer device and that communicate with a transfer device via the removable electronic card (SIM) connector.

Preferably, this radiocommunication device includes means for changing modes between a first normal operating mode, that requires the presence of the removable electronic card (SIM), and a second data transfer mode, that requires a connector instead of said removable electronic card (SIM).

The invention also relates to data transfer devices from and/or to a radiocommunication device and which can communicate with said radiocommunication device via the connector for removable electronic card (SIM).

The invention also relates to connection means of a radiocommunication device with a transfer device, designed to connect said transfer device to said radiocommunication device via a housing for a removable electronic card (SIM) of said radiocommunication device.

These connection means advantageously comprise means for adapting between the SIM format and a predetermined format of said transfer device.

Other characteristics and advantages of the invention will become more evident by reading the following description of a preferred embodiment of the invention and through diagrams in which:

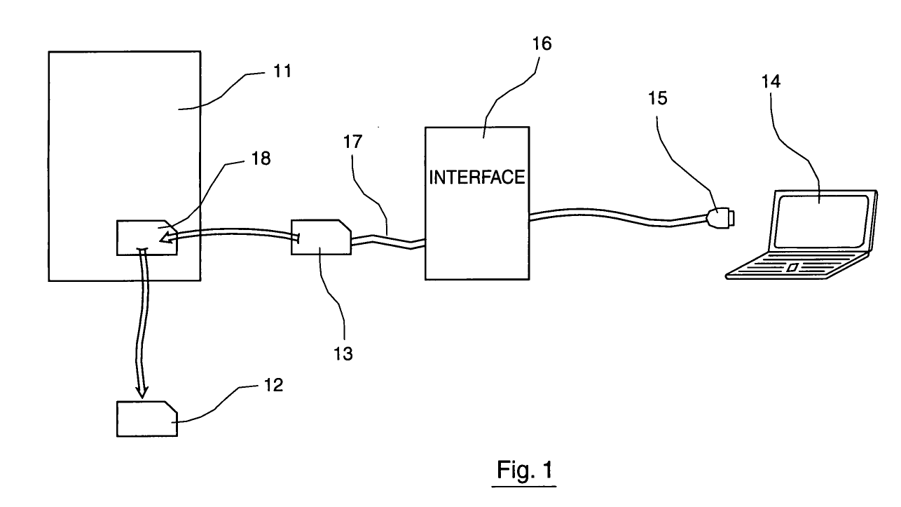

FIG. 1 illustrates a diagram of the principle of the invention;

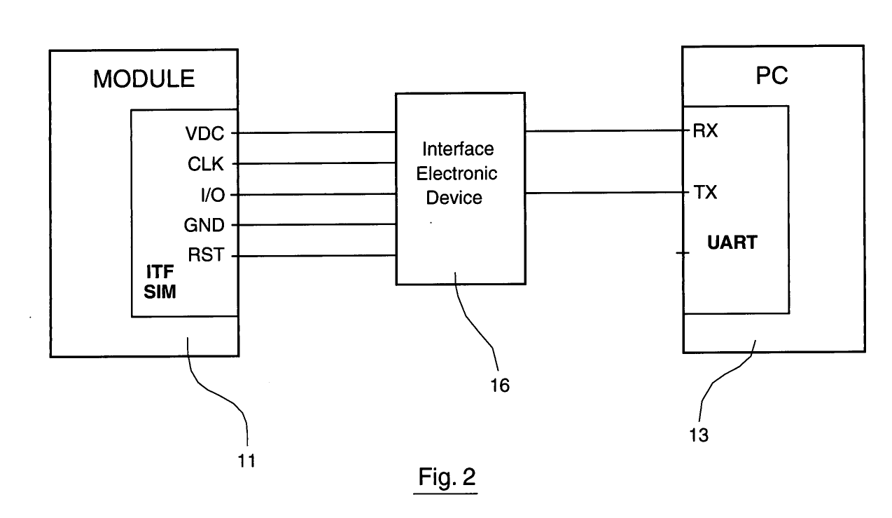

FIG. 2 illustrates the electric implementation aspect of the system described in FIG. 1.

FIG. 1 provides a diagram of the general principle of the invention.

In a traditional wireless telephone 11, the SIM card 12, which notably contains the data relative to the user subscription is extracted.

The terminal 11 can, of course, also be included in any type of machine that needs to communicate by using a radiocommunication system, for example, GSM or GPRS, a remote measuring system, an automobile, etc. In the latter case, the SIM card can, for example, be accessible in the boot of the vehicle, in the glove compartment, or in another location selected by the manufacturer.

According to the invention, a connector 13 is placed in the location of the SIM card 12, this connector has the same format and is equipped with electric contacts matching those of the terminal 11, which generally allow dialoguing with the SIM card 12.

This connector 13 is linked to a read and/or write (programming) device 14, for example a PC type device.

This PC 14 contains the data that must be downloaded into the terminal 11. For example, this can be a specific application, in particular for devices that are mounted on machines or vehicles, a software update, or partial software update, data specific to an application or user, etc.

The invention can also be used, of course, to collect the data contained in the terminal 11.

This way, a universal interface is obtained, viewed from the terminal end. Indeed, all wireless telephones and similar devices are equipped with a housing 18 for receiving the SIM card. This housing is always accessible because users must be able to change their SIM card when necessary. It is therefore also possible to extract this SIM card and replace it with the connector 13.

Consequently, it is not necessary for the terminals to be equipped with a specific connection for downloading data. At the data downloading system end, it is no longer necessary to have a series of connection cables that would allow adapting to any type of terminal or manufacturer.

This interface can be equipped with, at the server end, any type of standard serial connector and, for example, a UART, SPI, or USB 15 port.

An interface electronic device 16 is placed on the cable 17 that links connector 13 and connector 15 for making the necessary adaptations between the inputs and outputs of the terminal end and the server end.

Consequently, as illustrated in FIG. 2, this interface electronic device 16 can be designed to interconnect inputs and outputs of a SIM standard:
VDC
CLK
I/O
GND
RST to a PC inputs and outputs, for example, via a UART interface;
RX
TX

The terminal 11 is equipped with specific software contained, for example, in the radiocommunication module (for example, WISMO (trademark)), which allows the terminal to take in charge the connector 13, when there is no SIM card present, and to dialog with the server. The server, in turn, includes application software that can manage this dialogue.

By correctly programming the SIM interface, it can be observed that the PC and the module can communicate at a standard UART speed.

For this purpose, the terminal 11 must include means that allow managing two distinct modes:
a mode in presence of a SIM card, traditional in itself;
a mode in presence of a connector 13, according to the invention.

This change in mode can be done in an automatic manner; the terminal can recognise the presence of the connector 13, for example, using a specific contact. There can also be a specific action that commands the switch from one mode to the others, either by entering a code in a keypad, receiving a mode change request (for example by SMS), or by any other appropriate means.

1. Method for connecting a radiocommunication device to a data transfer device, wherein the method comprises:
connecting said radiocommunication device via a housing for receiving and connecting a removable electronic card; and
transferring data in a data transfer stage from said radiocommunication device to said transfer device.

2. Method according to claim 1, wherein the method comprises the following stages:
extracting the removable electronic card;
inserting into said housing a connector with a connection format that includes at least one link point that is compatible with a link point equipped in said radiocommunication device for receiving said removable electronic card;
transferring the data between said transfer device and said radiocommunication device.

3. Method according to claim 1, wherein the method allows two operating modes of said radiocommunication device; a first normal operating mode that requires the presence of said removable electronic card connected to the housing, and a second data transfer mode that requires a connector connected to the housing instead of said removable electronic card.

4. Method according to claim 3, wherein said radiocommunication device goes into said second mode due to at least one of the following actions:
reception by said radiocommunication device of a specific command;
detection of the presence of a specific transfer connector and/or absence of the removable electronic card; and
action on at least one key of said radiocommunication device.

5. Method according to claim 1, wherein the data transferred in the data transfer stage comprises at least one of the elements belonging to the group that comprises:
specific implementation programs for said radiocommunication device according to a predetermined application;
program and/or parameter updates;
configuration data of at least one program; and
data dedicated to at least one program.

6. (canceled)

7. Radiocommunication device that can be connected to a data transfer device, wherein the radiocommunication device comprises a removable electronic card connector and communicates with said transfer device via the removable electronic card connector.

8. Radiocommunication device according to claim 7 and further comprising means for changing modes between a first normal operating mode, that requires the presence of a removable electronic card connected to the removable electronic card connector, and a second data transfer mode, that requires a connector connected to the removable electronic card connector instead of said removable electronic card.

9. Data transfer device from and/or to a radiocommunication device, wherein the data transfer device communicates with said radiocommunication device via a connector for a removable electronic card.

10. Means for connecting a radiocommunication device with a transfer device, wherein the means connects said transfer device to said radiocommunication device via a housing for a removable electronic card of said radiocommunication device.

11. Connection means according to claim 10, characterised in that they comprise means (16) for adapting between the SIM format and a predetermined format of said transfer device.

12. Method of claim 1 wherein the housing for receiving and connecting a removable electronic card is configured to receive and connect a removable electronic SIM card.

13. Radiocommunication device according to claim 7, wherein the removable electronic card connector comprises a removable electronic SIM card connector.

14. Data transfer device according to claim 9, wherein the connector of the radiocommunications device is a removable electronic SIM card connector, and the data transfer device comprises a connector having contacts that match the removable electronic SIM card connector.

15. Means for connecting according to claim 10, wherein the housing is a housing for a removable electronic SIM card and the means for connecting comprises contacts configured for connecting to corresponding contacts of the housing.
